(19) United States
(12) Patent Application Publication
(10) Pub. No.: US 2009/0004366 A1
(43) Pub. Date: Jan. 1, 2009

(54) PROCESS FOR PRODUCING ELECTRODE-FORMED GLASS SUBSTRATE

(75) Inventors: Hitoshi ONODA, Koriyama-shi (JP); Satoshi FUJIMINE, Koriyama-shi (JP); Kenji IMAKITA, Chiyoda-ku (JP); Yasuko OSAKI, Chiyoda-ku (JP); Hiroyuki YAMAMOTO, Koriyama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Chiyoda-ku (JP)

(21) Appl. No.: 12/133,038

(22) Filed: Jun. 4, 2008

(30) Foreign Application Priority Data
Jun. 28, 2007 (JP) 2007-170789
Jul. 11, 2007 (JP) 2007-182041
Apr. 24, 2008 (JP) 2008-113782

(51) Int. Cl. B05D 5/12; C03C 3/066

(52) U.S. Cl. 427/77; 501/79

(57) ABSTRACT

To provide a process for producing an electrode-formed glass substrate, which is capable of suppressing warpage without lowering the strength of a front substrate of a plasma display device.

Electrodes formed on a glass substrate are covered with a lead-free glass comprising, as represented by mass %, from 30 to 50% of B₂O₃, more than 25% and at most 35% of SiO₂, from 10 to 25% of ZnO, from 7 to 19% in total of K₂O and either one or both of Li₂O and Na₂O, from 0 to 5% of Al₂O₃, from 0 to 5% of MgO+CaO+SrO+BaO, and when the molar fractions of Li₂O, Na₂O and K₂O are represented by l, n and k, respectively, l is at most 0.025, and l+n+k is from 0.07 to 0.17.

### BACKGROUND OF THE INVENTION

1. Field of the Invention

The present invention relates to a lead-free glass for covering electrodes, a glass ceramic composition for covering electrodes and an electrode-formed glass substrate, which are suitable for producing a front substrate of a plasma display device (PDP), and a process for producing an electrode-formed glass substrate.

2. Discussion of Background

PDP is a representative large-screen full-color display device.

PDP is produced in such a manner that a front substrate to be used as a display surface and a rear substrate having a plurality of stripe- or waffle-shaped barrier ribs formed thereon are sealed as faced with each other, and discharge gas is introduced between such substrates.

The front substrate is one in which a plurality of display electrode pairs for inducing surface discharge are formed on a front glass substrate, and the electrode pairs are covered by transparent glass dielectrics. Electrode pairs usually consist of transparent electrodes made of e.g. ITO, and bus electrodes to be formed on a part of the surface of the transparent electrodes. As the bus electrodes, silver electrodes or Cr—Cu—Cr electrodes are used.

The rear substrate is usually one having barrier ribs and fluorescent layers formed on a rear glass substrate, in addition to address electrodes covered with glass.

The glass (dielectrics) covering electrodes on the front substrate, is formed by e.g. a method of transferring a green sheet containing a glass powder onto the electrodes, followed by firing, or applying a paste containing a glass powder on electrodes, followed by firing.

The glass forming a dielectric layer on the front substrate is required to be fired at a low temperature, to have high transparency after firing, and to have no coloration by silver diffused from the silver electrodes. Further, along with the production of a large-sized plasma TV, lately, the weight of a glass substrate has been brought up as an issue, and it has been studied to use a thinner glass substrate. However, in such a case, there is a concern such that the strength of the substrate may decrease. Therefore, in order to increase the strength of a PDP front substrate, it has been proposed to reduce the expansion coefficient of an electrode-covering layer (Nonpatent Document 1).

Further, other than such a problem that the strength of the front substrate may decrease, there is a problem such as warpage or breaking of the front substrate during firing the glass powder, and the following method is suggested to solve such a problem. That is, with respect to the linear expansion coefficients α_{A} and α_{B}, of the glass substrate and the electrode-covering glass (electrode-covering layer), it is possible to prevent warpage or breaking of the front substrate by satisfying (α_{A}−20×10⁻⁷/° C.)<α_{B}<α_{A} to bring the remaining stress of the glass substrate to be from −800 to +1,500 psi. Such an electrode-covering glass is particularly preferably one having a composition comprising, based on mass %, from 10 to 45% of B₂O₃, from 0.5 to 20% of SiO₂, from 20 to 55% of ZnO, from 3 to 20% of K₂O, from 0 to 10% of Na₂O, from 0 to 5% of CuO+Bi₂O₃+Sb₂O₃+CeO₂+MnO, and from 0 to 30% of Nb₂O₃+La₂O₃+WO₃ (Patent Document 1).

Further, the rear substrate is also desired to have high strength.

Patent Document 1: JP-A-2006-221942 (such as “0013”, “0017”, or “0022”)

Non-Patent Document 1: 2007 SID INTERNATIONAL SYMPOSIUM DIGEST pp 389-392

### SUMMARY OF THE INVENTION

The present inventors have applied the method suggested in Patent Document 1, to a conventional PDP glass substrate (which is PD 200 manufactured by Asahi Glass Company, Limited, wherein α_{A} is 83×10⁻⁷/° C., and which will be hereinafter sometimes referred to as “a conventional glass substrate”). As a result, they have found that the above method does not necessarily sufficiently satisfy the current demand relating to strength or warpage. That is, when the above particularly preferred glass for covering electrodes having a composition comprising, based on mass %, 35.5% of B₂O₃, 11.5% of SiO₂, 40% of ZnO, 9% of K₂O, 1% of Na₂O, 2% of CaO, and 1% of Al₂O₃, was used, followed by firing at 570° C. to cover the entire glass substrate, the falling ball strength H/H₀ and the warpage W, which will be described later, were 1.3 and −60 μm, respectively. Currently, the desired values of H/H₀ and W are at least 1.2 and from −50 to 50 μm, respectively. Therefore, the above glass for covering electrodes was not one to satisfy the current demand relating to suppression of warpage. Further, the above glass for covering electrodes had an average linear expansion coefficient α of 73×10⁻⁷/° C. within a range of from 50 to 350° C. and a softening point Ts of 596° C.

The present invention has an object to provide a glass for covering electrodes, a glass ceramic composition for covering electrodes, a process for producing an electrode-covering glass substrate and an electrode-covering glass substrate wherein the electrodes on the glass substrate are covered with such a glass for covering electrodes, which may be used in a case where a conventional glass substrate is used, and which can suppress warpage without decreasing the strength of the electrode-formed glass substrate such as a PDP front substrate or can increase the strength.

The present invention provides a lead-free glass for covering electrodes (the glass of the present invention) comprising, as represented by mass % based on the following oxides, from 30 to 50% of B₂O₃, more than 25% and at most 35% of SiO₂, from 10 to 25% of ZnO, from 7 to 19% in total of K₂O and either one or both of Li₂O and Na₂O, and from 0 to 5% of Al₂O₃, wherein when it contains at least one component selected from the group consisting of MgO, CaO, SrO and BaO, the total of their contents is at most 5%, and when the molar fractions of Li₂O, Na₂O and K₂O are represented by l, n and k, respectively, l is at most 0.025, and l+n+k is from 0.07 to 0.17.

Further, the present invention provides the glass of the present invention wherein the lead-free glass for covering electrodes (the glass 1 of the present invention) has a SiO₂ content of more than 30%, a ZnO content of at most 20% and a total content of Li₂O, Na₂O and K₂O of at least 9%, and l+n+k is at least 0.09.

Further, the present invention provides the glass of the present invention wherein the lead-free glass for covering electrodes (the glass 2 of the present invention) has a B₂O₃content of at least 35%, a SiO₂ content of at most 30%, a total content of B₂O₃and SiO₂ of at least 60% and a total content of Li₂O, Na₂O and K₂O of at most 17%, and l+n+k is at most 0.15.

Further, the present invention provides the glass of the present invention wherein the lead-free glass for covering electrodes (the glass 3 of the present invention) has a B₂O₃content of at least 43%, a SiO₂ content of at most 33%, a total content of B₂O₃ and SiO₂ of at least 70%, a ZnO content of at most 23%, a Li₂O content of from 0 to 0.5%, a Na₂O content of from 2 to 5%, a K₂O content of from 4 to 9%, and a total content of Li₂O, Na₂O and K₂O of at most 12%. Further, it is also the glass 3 of the present invention, and one containing CuO in a range of at most 2.5%.

Further, the present invention provides a glass ceramic composition for covering electrodes (the glass ceramic composition of the present invention) comprising, a powder of a lead-free glass and a powder of a titanium oxide, wherein the lead-free glass comprises, as represented by mass % based on the following oxides, from 30 to 50% of B₂O₃, more than 25% and at most 33% of SiO₂, from 10 to 25% of ZnO, from 9 to 19% in total of K₂O and either one or both of Li₂O and Na₂O, and from 0 to 5% of Al₂O₃, and when the lead-free glass contains at least one component selected from the group consisting of MgO, CaO, SrO and BaO, the total of their contents is at most 5%, and when the molar fractions of Li₂O, Na₂O and K₂O are represented by l, n and k, respectively, l is at most 0.025, and l+n+k is from 0.08 to 0.17.

Further, the present invention provides a process for producing an electrode-formed glass substrate (the process for producing a glass substrate of the present invention) comprising forming electrodes on a glass substrate and covering the electrodes with glass, wherein the electrodes are covered by the glass of the present invention.

Further, the present invention provides a process for producing an electrode-formed glass substrate comprising forming electrodes on a glass substrate and covering the electrodes with glass, wherein the glass ceramic composition of the present invention, is fired to form glass to cover the electrodes. Moreover, such a process for producing an electrode-formed glass substrate, belongs to the process for producing a glass substrate of the present invention.

Further, the present invention provides PDP (PDP of the present invention) comprising a front glass substrate to be used as a display surface, a rear glass substrate and barrier ribs to define cells, wherein transparent electrodes of the front glass substrate or electrodes of the rear glass substrate are covered by the glass of the present invention.

The present inventors have found that the above l, n and k are factors which influence warpage W, but they have faced a new problem such that even if it is possible to adjust W to be small by limiting factors which influence W, in a specific range, the falling ball strength H/H₀ may also become small, whereby the above problem may not sometimes be solved.

In order to solve such a new problem, it is considered necessary to find factors which influence H/H₀ by measuring H/H₀. However, H, which will be described later, is one obtained by measuring the falling ball strength of a glass specimen (a glass layer-coated glass substrate) made by coating a glass substrate with a glass paste, followed by firing, and one which tends to be influenced not only by the glass substrate or the glass for covering electrodes, but also by a vehicle composition or a firing condition of the glass paste.

Now, in order to increase the accuracy in the measurement of such H, it became clear that the number of the measurements, n, needed to be at least 5. Consequently, it was difficult to employ the method of finding the factors which influence H/H₀, by measuring H/H₀, since a tremendous amount of work was required for improvement of accuracy in measuring H.

Therefore, the present inventors have conducted a research for a method which is capable of estimating H/H₀ without a measurement. As a result, they have found that S and the measured falling ball strength H/H₀, were well matched as shown in Drawing 1, wherein S was obtained by calculation by the following formula by inserting an elastic modulus E (unit: GPa), a fracture toughness value Kc (unit: MPa·m^{1/2}) and α (unit: 10⁻⁷/° C.) of the electrode-covering glass, and α (unit: 10⁻⁷/° C.) of a glass substrate i.e. α₀. By carrying out the study by using such a method, namely, a method to estimate H/H₀ by using S, the present invention has been accomplished. Further, with respect to the calculation for S, when α₀ is, for example, 83×10⁻⁷/° C., α₀ in the following formula is represented by 83, and the same applies to E, Kc and α. Further, H/H₀ is approximately S±0.2.

S=[13.314×Kc+0.181×(α₀−α)]²/E

### BRIEF DESCRIPTION OF DRAWING

FIG. 1 is a graph showing the relation between the calculated value and the measured value of the falling ball strength of a glass layer-coated glass substrate.

FIG. 1 is obtained by using a conventional glass substrate as the glass substrate. The abscissa represents the above S, and the ordinate represents the above H/H₀. Further, the compositional ranges, as represented by mass %, of the electrode-covering glass used for preparing Drawing 1, are from 1.2 to 40.6% of B₂O₃, from 0.4% to 33.3% of SiO₂, from 0 to 39.6% of ZnO, from 0 to 4.4% of Li₂O, from 0 to 4.9% of Na₂O, from 0 to 11.2% of K₂O, from 0 to 14.9% of Al₂O₃, from 0 to 0.4% of MgO, from 0 to 14.6% of BaO, from 0 to 2.1% of TiO₂, from 0 to 54.3% of Bi₂O₃ and from 0 to 86.1% of PbO.

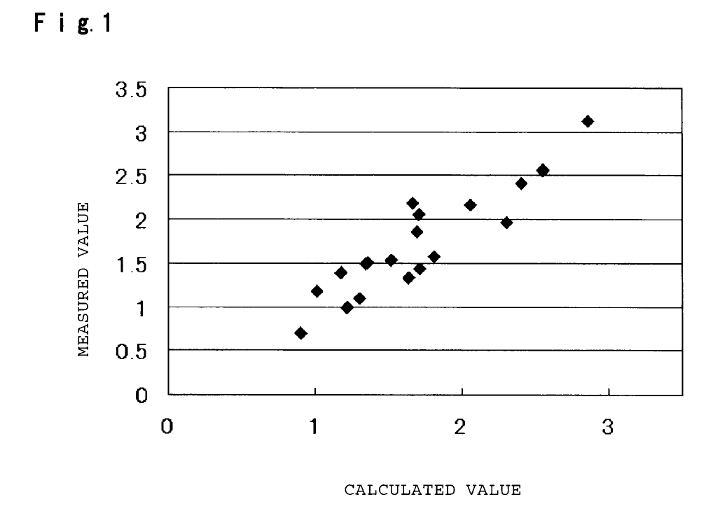

E, Kc and α are, respectively, values of physical properties of the electrode-covering glass itself, and they are not influenced by a vehicle composition or a firing condition of the glass paste. Therefore, in such a method to estimate H/H₀, there is no such problem as mentioned above in measuring H.

Kc is measured, for example, as follows.

Molten glass is poured into a stainless steel frame and annealed.

The annealed glass is formed into a plate-form glass, and its one side is mirror-polished, followed by annealing (precise annealing) to remove the remaining stress, thereby to obtain a glass specimen having a typical size of 50 mm×50 mm and a thickness of 10 mm. Here, the precise annealing is carried out in such a manner that, when the glass transition point of the glass is represented by Tg, the glass is held at from Tg to (Tg+20° C.) for one hour and then cooled to room temperature at a temperature-lowering rate of 1° C./min.

By using such a glass specimen, Kc is measured in accordance with JIS R 1607-1995 “Testing methods for fracture toughness of fine ceramics 5.1 IF method (indenter pressing method)”. That is, by using a Vickers hardness tester, inside a globe box having a relative humidity of 35%, a Vickers indenter is pressed against the surface of the glass specimen for 15 seconds, and the diagonal length of indentation and cracking length are measured by using a microscope attached to the tester. The Vickers hardness (Hv) is obtained from the pressing load and the diagonal length, and Kc is calculated from the cracking length, Hv, E and the pressing load. The pressing load is, for example, from 100 g to 2 kg.

α is measured, for example, as follows.

The annealed glass is formed into a cylindrical form having a length of 20 mm and a diameter of 5 mm, and the average linear expansion coefficient a from 50 to 350° C. is measured by using quarts glass as standard and a horizontal differential detection system thermal dilatometer TD 5010SA-N manufactured by Brucker AXS K.K.

E is measured, for example, as follows.

The annealed glass is formed into a plate-form having a thickness of 10 mm, and the elastic modulus E is measured by JIS R 1602-1995 “Testing methods for elastic modulus of fine ceramics 5.3 Ultrasonic pulse method”.

H/H₀ is measured as follows.

Typically, a glass substrate having a size of 100 mm×100 mm and a thickness of 2.8 mm, is placed on a water-resistant polishing paper having a production particle size of #1500. From a height of 10 cm from the upper surface of the glass substrate, 22 g of a stainless steel ball is dropped. If the glass substrate does not break by the drop of the stainless steel ball, the dropping height is adjusted to be 10 mm higher, and the stainless steel ball is dropped again. Until the glass substrate breaks, the dropping height is adjusted to be higher by 10 mm each time, and the stainless steel ball is then dropped.

Such a breaking test of glass substrate is carried out for five times, and an average value of the obtained breaking heights is represented by H₀.

H is an average value of breaking heights measured in the same manner as for H₀, with respect to a glass layer-coated glass substrate having one surface of the glass substrate covered with an electrode-covering glass.

That is, H is an average value of breaking heights obtained by carrying out the breaking test of the glass layer-coated glass substrate for five times in the same manner as H₀ measurement, except that the surface covered with an electrode-covering glass is faced down and put on the above water-resistant polishing paper.

The above glass layer-coated glass substrate is produced as follows.

100 g of a powder of the electrode-covering glass was kneaded with 25 g of an organic vehicle having 10 mass % of ethyl cellulose dissolved in α-terpineol or the like, to prepare a glass paste. The paste was uniformly screen-printed on a glass substrate having a size of 100 mm×100 mm, and dried at 120° C. for 10 minutes. Then, such a glass substrate was heated at a temperature-raising rate of 10° C. per minute up to Ts of the electrode-covering glass or a temperature in a range of from (Ts−50° C.) to Ts, and maintained at the temperature for 30 minutes to carry out firing, whereby an electrode-covering glass layer was formed on the glass substrate, which is regarded as a glass layer-coated glass substrate.

According to the present invention, it is possible to decrease warpage of the glass substrate after firing which is carried out during the production of a PDP front substrate without decreasing the strength of the PDP front substrate, etc., or it is possible to increase the strength of the PDP front substrate, etc.

Further, according to a preferred mode of the present invention, it is possible to obtain a glass for covering electrodes having a low dielectric constant, and for example, it is possible to reduce power consumption of PDP. Further, when such a glass is used for covering address electrodes of a PDP rear substrate, it is possible to suppress the increase of the dielectric constant while increasing reflectance by incorporating a titanium oxide powder having a high dielectric constant to the address electrode-covering glass.

### DETAILED DESCRIPTION OF THE PREFERRED EMBODIMENTS

The present invention is suitable when α of the glass substrate i.e. α₀ is from 78×10⁻⁷ to 88×10⁻⁷/° C., particularly from 80×10⁻⁷ to 86×10⁻⁷/° C.

The glass of the present invention is usually ground and classified, and used in the form of a powder.

In a case where the electrodes are to be covered by a glass paste, the powdered glass of the present invention (hereinafter referred to as “the glass powder of the present invention”) is kneaded with a vehicle to obtain a glass paste. The glass paste is applied on a glass substrate on which electrodes such as transparent electrodes are formed, and fired to form a glass layer for covering the transparent electrodes.

In a case where the electrodes are to be covered by a green sheet, the glass powder of the present invention is kneaded with a resin, and the kneaded product obtained is applied on a supporting film such as a polyethylene film to obtain a green sheet. This green sheet is transferred onto electrodes formed, for example, on a glass substrate, and fired to form a glass layer for covering the electrodes.

Now, in the production of a PDP front substrate, such firing is carried out typically at a temperature of at most 600° C. Further, the glass substrate having a glass layer formed in such a manner is the glass substrate of the present invention.

An average particle diameter (D₅₀) of the glass powder of the present invention is preferably at least 0.5 μm. If D₅₀ is less than 0.5 μm, it may take a too much time for such powderization. D₅₀ is more preferably at least 0.7 μm. Further, the above average particle diameter is preferably at most 4 μm, more preferably at most 3 μm.

The maximum particle diameter of the glass powder of the present invention is preferably at most 20 μm. If the maximum particle diameter exceeds 20 μm, the surface of the glass layer becomes so uneven as to distort an image on the PDP in the use for formation of an electrode-covering glass layer (transparent dielectric layer) of a PDP front substrate, wherein the thickness is required to be usually at most 30 μm. The maximum particle diameter is more preferably at most 10 μm.

Ts of the glass of the present invention is preferably at most 630° C. If it exceeds 630° C., it may be difficult to obtain a high transmittance glass layer by the firing at a temperature of at most 600° C. It is more preferably at most 620° C., typically at most 615° C. or 610° C.

Further, Ts is preferably at least 500° C. If Ts is lower than 500° C., a resin component contained in a glass paste or a green sheet may not be sufficiently decomposed in the firing step.

In a case where power consumption of PDP is to be lowered, the relative dielectric constant (ε) of the glass of the present invention at 1 MHz, is preferably at most 8.5, more preferably at most 7, particularly preferably at most 6.4.

Kc of the glass of the present invention is preferably at least 0.74 MPa·m^{1/2}, more preferably at least 0.76 MPa·m^{1/2}, particularly preferably at least 0.78 MPa·m^{1/2}. Kc is a value of a physical property relating to the strength of a glass material, and it is an important element to control the strength of an electrode-covering glass layer. Further, it is also an important element to control the strength of a glass substrate having such an electrode-covering glass layer formed on its surface, such as the glass substrate of the present invention or the front substrate of PDP of the present invention.

The breaking of the PDP front substrate is considered to happen in such a manner that when an impact is exerted on the PDP front substrate, and the substrate is deformed, an electrode-covering glass layer which is partially in contact with barrier ribs formed on the rear substrate, crashes to such ribs and becomes damaged. However, since Kc of the glass of the present invention is at least, for example, 0.74 MPa·m^{1/2}, it is considered that even if the electrode-covering glass layer becomes damaged like above, it is rare that the damage reaches breaking.

E of the glass of the present invention is from 55 to 80 GPa, more preferably at most 75 GPa.

The breaking of the PDP front substrate is considered to happen in the above-mentioned manner such that the barrier ribs formed on the rear substrate and the electrode-covering glass layer crash to each other and become damaged. Moreover, it is considered that when E of the electrode-covering glass layer at that time, is smaller, the impact by the crashing is more absorbed, and damage will rarely be formed. Since E of the glass of the present invention is, for example, at most 80 GPa, it is considered that the damage is rarely formed by crashing and hardly reaches breaking.

The strength of glass material constituting an electrode-covering layer, is governed by Kc, etc., but in a case of the electrode-covering glass layer-coated glass substrate, the strength of the electrode-covering layer becomes high or low depending on the stress formed by the difference between a of the glass substrate i.e. α₀ and α of the electrode-covering glass layer, in the step of cooling to room temperature after the step of firing to form the electrode-covering glass layer. That is, when α of the electrode-covering glass layer is smaller than α₀, the compressional stress is exerted on the surface of the electrode-covering glass layer, whereby the strength of the electrode-covering glass layer becomes high. When α is greater than α₀, the tensile stress is exerted, whereby the strength of the electrode-covering glass layer becomes low.

When α₀ is from 80×10⁻⁷ to 86×10⁻⁷/° C., α of the glass of the present invention is preferably from 65×10⁻⁷ to 90×10⁻⁷/° C. If α of the glass of the present invention exceeds 90×10⁻⁷/° C., when the glass is used for covering electrodes on the glass substrate, the strength of the electrode-covering glass layer-coated substrate, may decrease. α of the glass of the present invention is more preferably at most 85×10⁻⁷/° C. Further, if α of the glass of the present invention is less than 65×10⁻⁷/° C., the stress to be formed by the difference with α of the glass substrate i.e. α₀, becomes too large, whereby the substrate may be deformed or broken. α of the glass of the present invention is more preferably at least 67×10⁻⁷/° C. When the stress formed at the interface with the glass substrate is desired to be smaller, it is preferred to adjust α to be from 70×10⁻⁷/° C. to 85×10⁻⁷/° C. When the strength is desired to be higher, it is more preferred to adjust α to be from 65×10⁻⁷/° C. to 80×10⁻⁷/° C.

Typically, the glass 1 of the present invention essentially comprises, as represented by mass % based on the following oxides, from 30 to 50% of B₂O₃, more than 30% and at most 35% of SiO₂, from 10 to 20% of ZnO, from 9 to 19% of Li₂O +Na₂O +K₂O, and from 0 to 5% of Al₂O₃, and it contains K₂O and at least one of Li₂O and Na₂O. When the glass 1 of the present invention contains at least one component selected from the group consisting of MgO, CaO, SrO and BaO, the total of their contents is at most 5%, and when the molar fractions of Li₂O, Na₂O and K₂O are represented by l, n and k, respectively, l is at most 0.025, and l+n+k is from 0.09 to 0.17.

With reference to such a typical embodiment, components, etc. of the glass 1 of the present invention will be as follows. Further, a molar fraction is one having the content by mol % divided by 100.

B₂O₃ is a component to stabilize the glass or to lower Ts, and is essential. Further, it has an effect to lower ε. If B₂O₃ is less than 30%, vitrification tends to be difficult. It is preferably at least 32%, more preferably at least 35%. If B₂O₃ exceeds 50%, phase separation tends to take place. Or, chemical durability may decrease. It is preferably at most 45%, typically at most 42%.

SiO₂ is a component to form the matrix of the glass, and is essential. Further, it has an effect to lower ε. If SiO₂ is less than 30%, warpage tends to be large. It is considered that the matrix component of the glass decreases, and alkali metal ion exchange tends to take place between the electrode-covering glass and the glass substrate. SiO₂ is typically at least 30.1%. If it exceeds 35%, Ts tends to be high. It is preferably at most 33%.

ZnO is a component to lower Ts and α, and is essential. If ZnO is less than 10%, α may be large. It is preferably at least 12%. If ZnO exceeds 20%, the glass tends to be unstable. Further, ε may be too large. ZnO is preferably at most 17%.

Further, the molar fraction of ZnO is typically less than 0.20.

Li₂O, Na₂O and K₂O are, respectively, components to facilitate vitrification or to lower Ts, and also components to increase α, to lower Kc and to increase ε.

At least one of Li₂O and Na₂O must be contained. If neither Li₂O nor Na₂O is contained, Ts will be high, or warpage will be large.

When Li₂O is contained, its molar fraction l is at most 0.025. If it exceeds 0.025, there will be a large convex warpage on the side where the glass layer is not formed. It is considered that in alkali metal ion exchange between the electrode-covering glass layer and the glass substrate, Li ions having small radius will penetrate into the surface of the glass substrate, whereby the surface of the glass substrate in contact with the electrode-covering glass layer will shrink. l/(l+n+k) is preferably at most 0.2.

Na₂O is preferably contained in a range of at most 7%. If it exceeds 7%, warpage may be large, or Kc may decrease. It is more preferably at most 6%.

K₂O is a component to decrease warpage, and is essential.

K ions have large ionic radius, and are hard to transfer as compared with other alkali metal ions, so that it is considered that when K₂O is contained, alkali metal ion exchange is made to be hard to proceed. K₂O is preferably contained at least 2%, more preferably at least 5%.

However, if only K₂O is contained as an alkali metal component, when a glass layer is formed on one side of a glass substrate, a convex warpage will be formed on the side where the glass layer is formed. It is considered that K ions having large ion radius penetrate into the surface of the glass substrate, whereby the surface of the glass substrate in contact with the electrode-covering glass layer may expand.

When the total content R₂O of Li₂O, Na₂O and K₂O is less than 9%, and l+n+k is less than 0.09, Ts will be high. Typically, R₂O is at least 12%, and l+n+k is at least 0.1. If R₂O exceeds 19%, and l+n+k exceeds 0.17, α will be large. Further, Kc will be small. Preferably R₂O is at most 17%, and l+n+k is at most 0.15.

Al₂O₃ is not essential, but it may be contained in a range of at most 5% to increase the glass stability or Kc, etc. If it exceeds 5%, when silver electrodes are covered, a phenomenon tends to take place, such that silver diffuses in the electrode-covering glass and develops a color (silver coloration). It is preferably at most 3%. When it is desired to prevent silver coloration, Al₂O₃ is preferably less than 1%, more preferably not contained.

Further, the molar fraction of Al₂O₃ is typically less than 0.04.

The total content of B₂O₃, SiO₂ and Al₂O₃ is preferably at least 62%. If it is less than 62%, Kc tends to be low. The total content is typically at least 69%.

The typical embodiment of the glass 1 of the present invention essentially comprises the above components, and it is possible to further contain other components within a range not to impair the object of the present invention. In such a case, the total content of components other than the above components, is preferably at most 12%, more preferably at most 10%, typically at most 5%. Typical representatives of such components are as follows.

MgO, CaO, SrO and BaO, respectively, are not essential, but they may sometimes have an effect of stabilizing the glass or reducing α. For such a purpose, it is possible to incorporate at least one member of the four components in a range of at most 5% in total of their contents. If it exceeds 5%, Kc tends to be small. It is more preferably at most 3%. Further, the total of the respective molar fractions of the above four components is typically less than 0.05.

When BaO is contained, its content is preferably at most 1%. If it exceeds 1%, Kc tends to decrease. If Kc is desired to be larger, it is preferred not to contain BaO.

When it is desired to suppress a phenomenon such that the binder is not removed sufficiently at the time of firing, whereby carbon remains in the glass after firing, and the glass is colored, three components such as CuO, CeO₂ and CoO may be incorporated up to 3% in total of their contents. If the total content exceeds 3%, the coloration of the glass will conversely become remarkable. The total content is typically at most 1.5%.

When either one of such three components is contained, it is typical to contain CuO in a range of at most 1.5%.

For improvement of sintering property, etc., Bi₂O₃ may be contained up to 5%, but from a viewpoint such that Bi₂O₃ has a resource problem, etc., it is preferred not to contain Bi₂O₃.

A component such as TiO₂, ZrO₂, SnO₂ or MnO₂ is exemplified as a component which may be used for a purpose of adjusting α, Ts, chemical durability, glass stability, transmittance of a glass-covering layer, etc., and of suppressing the silver coloration phenomenon.

Further, the glass 1 of the present invention does not contain PbO.

The glass 1 of the present invention is preferred when it is desired to reduce warpage or suppress a silver coloration.

Typically, the glass 2 of the present invention essentially comprises, as represented by mass % based on the following oxides, from 35 to 50% of B₂O₃, more than 25% and at most 30% of SiO₂, from 10 to 25% of ZnO, from 7 to 17% of Li₂O+Na₂O+K₂O, and from 0 to 5% of Al₂O₃, and it contains K₂O and at least one of Li₂O and Na₂O. B₂O₃+SiO₂ is at least 60%. When the glass 2 of the present invention contains at least one component selected from the group consisting of MgO, CaO, SrO and BaO, the total of their contents is at most 5%, and when the molar fractions of Li₂O, Na₂O and K₂O are represented by l, n and k, respectively, l is at most 0.025, and l+n+k is from 0.07 to 0.15.

With reference to such a typical embodiment, components, etc. of the glass 2 of the present invention will be as follows. Further, a molar fraction is one having the content by mol % divided by 100.

B₂O₃ is a component to stabilize the glass or to lower Ts, and is essential. Further, it has an effect to lower ε. If B₂O₃ is less than 35%, vitrification tends to be difficult. It is preferably at least 37%, and it is preferably at least 40% when ZnO is less than 15%. If B₂O₃ exceeds 50%, phase separation tends to take place. Or, chemical durability may decrease. It is preferably at most 45% when ZnO is at least 15%. It is typically at most 42%.

When ε is desired to be small, B₂O₃ is preferably at least 44%.

SiO₂ is a component to form the matrix of the glass, and is essential. Further, it has an effect to lower ε. If SiO₂ is less than 25%, Kc tends to be small, or warpage tends to be large. It is considered that the matrix component of the glass decreases, and alkali metal ion exchange tends to take place between the electrode-covering glass and the glass substrate. SiO₂ is typically at least 25.1%. If it exceeds 30%, Ts tends to be high. It is preferably at most 29%.

When the total cocontent of B₂O₃ and SiO₂ is less than 60%, Kc may be lowered. It is typically at least 64%.

ZnO is a component to lower Ts and α, and is essential. If ZnO is less than 10%, a may be large. It is preferably at least 11%.

When α is desired to be lowered, ZnO is preferably at least 15%, more preferably at least 17%. If ZnO exceeds 25%, the glass tends to be unstable, crystal tends to precipitate at the time of firing, or ε may be large. ZnO is preferably at most 24%.

When it is desired to increase the glass stability, ZnO is preferably less than 15%.

Li₂O, Na₂O and K₂O are, respectively, components to facilitate vitrification or to lower Ts, and also components to increase α, to lower Kc and to increase ε.

At least one of Li₂O and Na₂O must be contained. If neither Li₂O nor Na₂O is contained, Ts will be high, or warpage will be large.

When Li₂O is contained, its molar fraction l is at most 0.025. If it exceeds 0.025, there will be a large convex warpage on the side where the glass layer is not formed. It is considered that in alkali metal ion exchange between the electrode-covering glass layer and the glass substrate, Li ions having small radius will penetrate into the surface of the glass substrate, whereby the surface of the glass substrate in contact with the electrode-covering glass layer will shrink. l/(l+n+k) is preferably at most 0.2.

Na₂O is preferably contained in a range of at most 7%. If it exceeds 7%, warpage tends to be large, or Kc tends to decrease. It is more preferably at most 6%.

K₂O is a component to decrease warpage, and is essential.

K ions have large ionic radius, and are hard to transfer as compared with other alkali metal ions, so that it is considered that when K₂O is contained, alkali metal ion exchange is made to be hard to proceed. K₂O is preferably contained at least 2%, more preferably at least 5%.

However, if only K₂O is contained as an alkali metal component, when a glass layer is formed on one side of a glass substrate, a convex warpage will be formed on the side where the glass layer is formed. It is considered that K ions having large ion radius penetrate into the surface of the glass substrate, whereby the surface of the glass substrate in contact with the electrode-covering glass layer may expand.

When the total content R₂O of Li₂O, Na₂O and K₂O is less than 7%, and l+n+k is less than 0.07, Ts will be high. Typically, R₂O is at least 8%, and l+n+k is at least 0.09. If R₂O exceeds 17%, and l+n+k exceeds 0.15, α will be large. Further, Kc will be small. Preferably R₂O is at most 16%, and l+n+k is at most 0.14.

When the content of ZnO is less than 15%, R₂O is preferably at least 10%. If R₂O is less than 10%, Ts tends to be large.

When the content of ZnO is at least 15%, R₂O is preferably at most 14%. If R₂O exceeds 14%, Kc tends to be low. Such embodiment is preferred when α is desired to be lowered, etc.

Al₂O₃ is not essential, but it may be contained in a range of at most 5% to increase the glass stability or Kc, etc. If it exceeds 5%, when silver electrodes are covered, a phenomenon tends to take place, such that silver diffuses in the electrode-covering glass and develops a color (silver coloration). It is preferably at most 3%. When it is desired to prevent silver coloration, Al₂O₃ is preferably less than 1%, more preferably not contained.

Further, the molar fraction of Al₂O₃ is typically less than 0.04.

The total content of B₂O₃, SiO₂ and Al₂O₃ is preferably at least 62%. If it is less than 62%, Kc tends to be low. The total content is typically at least 69%.

The typical embodiment of the glass 2 of the present invention essentially comprises the above components, and it is possible to further contain other components within a range not to impair the object of the present invention. In such a case, the total content of components other than the above components, is preferably at most 12%, more preferably at most 10%, typically at most 5%. Typical representatives of such components are as follows.

MgO, CaO, SrO and BaO, respectively, are not essential, but they may sometimes have an effect of stabilizing the glass or reducing α. For such a purpose, it is possible to incorporate at least one member of the four components in a range of at most 5% in total of their contents. If it exceeds 5%, Kc tends to be small. It is more preferably at most 3%. Further, the total of the respective molar fractions of the above four components is typically less than 0.05.

When BaO is contained, its content is preferably at most 1%. If it exceeds 1%, Kc tends to decrease. If Kc is desired to be larger, it is preferred not to contain BaO.

When it is desired to suppress a phenomenon such that the binder is not removed sufficiently at the time of firing, whereby carbon remains in the glass after firing, and the glass is colored, three components such as CuO, CeO₂ and CoO may be incorporated up to 3% in total of their contents. If the total content exceeds 3%, the coloration of the glass will conversely become remarkable. The total content is typically at most 1.5%.

When either one of such three components is contained, it is typical to contain CuO in a range of at most 1.5%.

For improvement of sintering property, etc., Bi₂O₃ may be contained up to 5%, but from a viewpoint such that Bi₂O₃ has a resource problem, etc., it is preferred not to contain Bi₂O₃.

A component such as TiO₂, ZrO₂, SnO₂ or MnO₂ is exemplified as a component which may be used for a purpose of adjusting α, Ts, chemical durability, glass stability, transmittance of a glass-covering layer, etc., and of suppressing the silver coloration phenomenon.

Further, the glass 2 of the present invention does not contain PbO.

The glass 2 of the present invention is preferred when it is desired to increase strength without decreasing transparency of the electrode-covering glass layer.

Now, the glass 3 of the present invention will be as follows. Further, a molar fraction is one having the content by mol % divided by 100.

B₂O₃ is a component to stabilize the glass, increase Kc, lower E or lower ε, and is essential. If B₂O₃ is less than 43%, E will be large and the strength will tend to be reduced. It is preferably at least 44%. If B₂O₃ exceeds 50%, phase separation tends to take place. Or, chemical durability may decrease.

SiO₂ is a component to form the matrix of the glass, and is essential. Further, it has an effect to lower ε. If SiO₂ is less than 25%, Kc tends to be low, or warpage tends to be large. It is considered that the matrix component of the glass is less, and alkali metal ion exchange tends to take place between the electrode-covering glass and the glass substrate. If SiO₂ exceeds 33%, Ts will be high. It is preferably at most 32%, typically at most 29%.

If the total content of B₂O₃ and SiO₂ is less than 70%, Kc tends to be low.

ZnO is a component to lower Ts and α, and is essential. ZnO is a component to increase E and also a component to increase ε. If ZnO is less than 10%, α tends to be large. It is preferably at least 11%. If ZnO exceeds 23%, E will be large. It is preferably at most 19%. When ε is desired to be lowered, ZnO is preferably at most 15%.

Li₂O, Na₂O and K₂O are, respectively, components to facilitate vitrification or to lower Ts, components to increase α, to lower Kc or to increase E, and also components to reduce the strength or to increase ε.

Among them, K₂O is a component to decrease warpage, and is essential. If K₂O is less than 4%, warpage tends to be large.

The above effect is considered such that K ions have large ionic radius, and are hard to transfer as compared with other alkali metal ions, so that when K₂O is contained, alkali metal ion exchange is made to be hard to proceed.

However, if only K₂O is contained as an alkali metal component, when a glass layer is formed on one side of a glass substrate, a convex warpage will be formed on the side where the glass layer is formed. It is considered that K ions having large ion radius penetrate into the surface of the glass substrate, whereby the surface of the glass substrate in contact with the electrode-covering glass layer may expand. Further, K₂O is a component to increase ε and α, and its content is to be at most 9%.

Na₂O has a high effect to lower Ts, and is essential. If it is less than 2%, such an effect will be insufficient. If it exceeds 5%, α will be large.

Li₂O may be contained up to 0.5% when α is desired to be lowered. However, Li₂O is a component to increase E remarkably, and it is usually preferably not contained.

When Li₂O is contained, its molar fraction l is at most 0.025. If it exceeds 0.025, there will be a large convex warpage on the side where the glass layer is not formed. It is considered that in alkali metal ion exchange between the electrode-covering glass layer and the glass substrate, Li ions having small radius will penetrate into the surface of the glass substrate, whereby the surface of the glass substrate in contact with the electrode-covering glass layer will shrink. l/(l+n+k) is preferably at most 0.2.

When the total content R₂O of Li₂O, Na₂O and K₂O is less than 7%, and l+n+k is less than 0.07, Ts will be high. Typically, R₂O is at least 8%, and l+n+k is at least 0.08. If R₂O exceeds 12%, and l+n+k exceeds 0.17, α will be large, Kc will be lowered, or E will be increased. Preferably R₂O is at most 11%, and l+n+k is at most 0.15. More preferably R₂O is at most 10%, and l+n+k is at most 0.1.

Al₂O₃ is not essential, but it may be contained in a range of at most 5% to increase the glass stability or Kc, etc. If it exceeds 5%, when silver electrodes are covered, a phenomenon tends to take place, such that silver diffuses in the electrode-covering glass and develops a color (silver coloration). It is preferably at most 3%. When it is desired to prevent silver coloration, Al₂O₃ is preferably less than 1%, more preferably not contained.

Further, the molar fraction of Al₂O₃ is typically less than 0.04.

The glass 3 of the present invention essentially comprises the above components, and it is possible to further contain other components within a range where the object of the present invention is not impaired. In such a case, the total content of components other than the above components, is preferably at most 5%, more preferably at most 4%, typically at most 3%. Typical representatives of such components are as follows.

CuO may be contained up to 2.5% when it is desired to suppress a phenomenon such that the binder is not removed sufficiently at the time of firing, whereby carbon remains in the glass after firing, and the glass is colored. If it exceeds 2.5%, the coloration of the glass may conversely become remarkable. CuO is typically at most 1.5%.

For the same purpose as the purpose of incorporating the above CuO, CeO₂ or CoO may sometimes be contained in the range of at most 3% in total of such two components and CuO. If the total content exceeds 3%, the coloration of the glass may conversely become remarkable. It is preferably at most 2.5%, typically at most 1.5%.

A component such as TiO₂, ZrO₂, SnO₂ or MnO₂ is exemplified as a component which may be used for a purpose of adjusting α, Ts, chemical durability, glass stability, transmittance of a glass-covering layer, etc., and of suppressing the silver coloration phenomenon. When any one of them is contained, typically, ZrO₂ is contained in a range of at most 3%.

Further, the glass 3 of the present invention does not contain PbO.

The glass 3 of the present invention is preferred when it is desired to lower ε or increase the strength.

The glass ceramic composition of the present invention is typically used for covering address electrodes of a PDP rear substrate.

The components of the glass ceramic composition of the present invention and their contents will be described.

A powder of a lead-free glass is the main component of the glass ceramic composition for the electrode-covering layer, and is essential. The typical content is, as represented by mass %, from 90 to 99.9%.

Such a lead-free glass is the glass of the present invention, and its components, as represented by mass %, will be described.

B₂O₃ is a component to stabilize the glass or to lower Ts or ε, and is essential. If B₂O₃ is less than 30%, vitrification tends to be difficult. It is preferably at least 32%, more preferably at least 35%. If B₂O₃ exceeds 50%, phase separation tends to take place, or chemical durability tends to decrease. It is preferably at most 45%, typically at most 42%.

SiO₂ is a component to form the matrix of the glass and to lower ε, and is essential. If SiO₂ is at most 25%, ε tends to be large. It typically exceeds 26%. If it exceeds 33%, Ts tends to be high. It is preferably at most 32%.

ZnO is a component to lower Ts and α, and is essential. If it is less than 10%, a tends to be large. It is preferably at least 12%. If it exceeds 25%, the glass tends to be unstable, and ε tends to be too large. ZnO is preferably at most 20%, typically at most 18%.

Further, the molar fraction of ZnO is typically less than 0.20.

Li₂O, Na₂O and K₂O are, respectively, components to facilitate vitrification or to lower Ts, and also components to increase α, to lower Kc and to increase ε.

Among them, at least one of Li₂O or Na₂O must be contained. If neither Li₂O nor Na₂O is contained, Ts will be high, or warpage will be large.

When Li₂O is contained, its molar fraction l is at most 0.025. If it exceeds 0.025, there will be a large convex warpage on the side where the glass layer is not formed. It is considered that in alkali metal ion exchange between the electrode-covering glass layer and the glass substrate, Li ions having small radius will penetrate into the surface of the glass substrate, whereby the surface of the glass substrate in contact with the electrode-covering glass layer will shrink. l/(l+n+k) is preferably at most 0.2.

Na₂O is preferably contained in a range of at most 7%. If it exceeds 7%, warpage tends to be large, or Kc tends to decrease. It is more preferably at most 6%.

K₂O is a component to decrease warpage, and is essential when silver coloration is desired to be suppressed.

K ions have large ionic radius, and are hard to transfer as compared with other alkali metal ions, so that it is considered that when K₂O is contained, alkali metal ion exchange is made to be hard to proceed. K₂O is preferably contained at least 2%, more preferably at least 5%.

When the total content R₂O of Li₂O, Na₂O and K₂O is less than 10%, or l+n+k is less than 0.08, Ts will be high. Preferably, R₂O is at least 12%, and l+n+k is at least 0.1. More preferably, R₂O is at least 15%, and l+n+k is at least 0.12. If R₂O exceeds 19%, or l+n+k exceeds 0.17, α will be large, or Kc will be lowered. Preferably R₂O is at most 17%, and l+n+k is at most 0.15.

Al₂O₃ is not essential, but it may be contained in a range of at most 5% to increase the glass stability or Kc, etc. If it exceeds 5%, silver coloration tends to take place. It is preferably at most 3%. When it is desired to prevent the silver coloration, Al₂O₃ is preferably less than 1%, more preferably not contained.

Further, the molar fraction of Al₂O₃ is typically less than 0.04.

MgO, CaO, SrO and BaO, respectively, are not essential, but they may sometimes have an effect of stabilizing the glass or reducing α. For such a purpose, it is possible to incorporate at least one member of the four components in a range of at most 5% in total of their contents. If it exceeds 5%, Kc tends to be low. It is more preferably at most 3%. Further, the total of the respective molar fractions of the above four components is typically less than 0.05.

When BaO is contained, its content is preferably at most 1%. If it exceeds 1%, Kc tends to decrease. If Kc is desired to be larger, it is preferred not to contain BaO.

The typical embodiment of the lead-free glass to be used for the glass ceramic composition of the present invention, essentially comprises the above components, and it is possible to further contain other components within a range where the object of the present invention is not impaired. In such a case, the total content of components other than the above components, is preferably at most 12%, more preferably at most 10%, typically at most 5%. Typical representatives of such components are as follows.

When it is desired to suppress a phenomenon such that the binder is not removed sufficiently at the time of firing, whereby carbon remains in the glass after firing, and the glass is colored, three components such as CuO, CeO₂ and CoO may be incorporated up to 3% in total of their contents. If the total content exceeds 3%, the coloration of the glass will conversely become remarkable. The total content is typically at most 1.5%.

When either one of such three components is contained, it is typical to contain CuO in a range of at most 1.5%.

For improvement of sintering property, etc., Bi₂O₃ may be contained up to 5%, but from a viewpoint such that Bi₂O₃ has a resource problem, etc., it is preferred not to contain Bi₂O₃.

A component such as TiO₂, ZrO₂, SnO₂ or MnO₂ is exemplified as a component which may be used for a purpose of adjusting α, Ts, chemical durability, glass stability, transmittance of a glass-covering layer, etc., and of suppressing the silver coloration phenomenon.

Further, the lead-free glass is preferred to have Ts of at most 600° C. and ε of at most 7.0.

A powder of titanium oxide is a component to increase the reflectance of the electrode-covering layer, and the typical content is, as represented by mass %, from 0.1 to 10%.

H/H₀ of a glass layer-coated glass substrate wherein a glass layer made of the glass of the present invention is formed on one surface of the glass substrate, is preferably at least 1.2, more preferably at least 1.5.

Further, S of such a glass layer-coated glass substrate is at least 1.4, more preferably at least 1.7.

The glass layer-coated glass substrate wherein a glass layer made of the glass of the present invention is formed on one surface of the glass substrate, having a size of 100 mm×100 mm and a thickness of 2.8 mm, has a warpage W preferably in a range of from −50 to 50 μm, more preferably from −30 to 30 μm. Further, in the present specification, a large warpage, for example, means that an absolute value of W is large, and it is not a concern whether the warpage is convex or concave.

The measurement of W is carried out as follows. That is, by producing the same glass layer-coated glass substrate as one used for the measurement of the above H, warpage is measured by using a surface roughness meter along a portion of 100 mm in length on a diagonal. Further, W is regarded as negative when a convex warpage is formed on a side where the glass layer is formed.

As the glass substrate of the present invention, a PDP front substrate is typical, and in such a case, electrodes to be covered with the glass of the present invention are transparent electrodes of e.g. ITO, and bus electrodes such as silver electrodes or Cr—Cu—Cr electrodes, which are formed on parts of the surface of the transparent electrodes.

The process for producing the glass substrate of the present invention is suitable as a process for producing the PDP front substrate, and in such a case, it is possible to carry out the process in the same manner as in a known production process, except for using the glass of the present invention as a glass for covering the electrodes of the front substrate.

The process for producing the glass substrate of the present invention is suitable as a process for producing the PDP rear substrate, and in such a case, it is possible to carry out the process in the same manner as in a known production process, except for using the glass of the present invention as a glass for covering the electrodes of the rear substrate.

The PDP produced by the present invention may be a known PDP except that the glass of the present invention is used as a glass for covering the front substrate electrodes or rear substrate electrodes such as address electrodes, and the production may be carried out in the same manner as in a known production process except that the glass of the present invention is used as a glass for covering the front substrate electrodes or the rear substrate electrodes.

### EXAMPLES

Starting materials were formulated and mixed so that the composition would be as shown by mass % in lines from B₂O₃ to CuO in Table 1. Each mixture was heated to 1,250° C. and melted for 60 minutes by means of a platinum crucible. Examples 1 to 8 represent Examples for the glass 1 of the present invention, and Examples 9 and 10 represent Comparative Examples. Further, in Table 2, each glass component is shown by mol %.

The obtained molten glass was partly poured into stainless-steel rollers to be processed into flakes. The glass flakes obtained were subjected to dry grinding for 16 hours by an alumina ball mill, followed by airflow classification, to prepare a glass powder having a D₅₀ of from 2 to 4 μm.

Using this glass powder as a sample, a Ts (unit: ° C.) was measured by means of a differential thermal analyzer (DTA).

The rest of the above molten glass was poured into a stainless-steel frame and annealed. The annealed glass was partly processed into a cylindrical shape with a length of 20 mm and a diameter of 5 mm, and using a quartz glass as a standard sample, α of such a glass was measured by using a horizontal differential detection system thermal dilatometer, TD 5010SA-N, manufactured by Bruker AXS. The results are shown in Tables (unit: 10⁻⁷/° C.).

Further, circular electrodes having a diameter of 38 mm were formed on both sides of a plate-shape sample having a thickness of about 3 mm produced by using a part of the annealed glass, and the relative dielectric constant ε at 1 MHz was measured by using LCR meter 4192 A, manufactured by Yokokawa Hewlett-Packard Company. The results are shown in Tables. Further, “−” in Tables mean that measurements were not carried out.

The rest of the annealed glass was processed into a plate-shape having a thickness of 10 mm, and the elastic modulus E (unit: GPa) was measured in accordance with JIS R 1602-1995 “Testing methods for elastic modulus of fine ceramics 5.3 Ultrasonic pulse method”.

Further, one side of the above glass which was processed into a plate-shape, was mirror-polished, and in order to remove the remaining stress, the glass was held at a temperature of from 500° C. to 520° C. for one hour and then annealed. By using such a specimen, Kc (unit: MPa·m^{1/2}) was measured by the above method. However, the pressing load of the Vickers indenter was selected depending on the tendency for cracking and the size of cracks, and the measurement was carried out by using a load of 2 kg in Examples 1, 3 to 6 and 8, 300 g in Example 2 and 200 g in Examples 9 and 10.

Further, 100 g of the above glass powder was kneaded with 25 g of an organic vehicle having 10 mass % of ethyl cellulose dissolved in α-terpineol or the like, to prepare a glass paste. The paste was uniformly screen-printed on the above conventional glass substrate having a size of 100 mm×100 mm and a thickness of 2.8 mm, and dried at 120° C. for 10 minutes. Then, such a glass substrate was heated at a temperature-raising rate of 10° C. per minute up to 570° C., and maintained at the temperature for 30 minutes to carry out firing, whereby a glass layer was formed on the glass substrate.

Along a portion of 100 mm in length on a diagonal of such a glass layer-coated glass substrate, its warpage W (unit: μm) was measured by using a surface roughness meter.

By using values of E, Kc and α, which were obtained in the above manner, and using a value of α₀ of the glass substrate, the above S was calculated.

Further, H was measured with respect to such a glass layer-coated glass substrate, and by using separately measured H₀, H/H₀ was calculated.

The results of measurements or calculation are shown in Tables. “−” in Tables means that measurements were not carried out.

TABLE 1

| | Ex. | | | | | | | | | |
|---|---|---|---|---|---|---|---|---|---|---|
| | 1 | 2 | 3 | 4 | 5 | 6 | 7 | 8 | 9 | 10 |
| B₂O₃ | 39.9 | 32.3 | 35.1 | 35.3 | 39.3 | 40.2 | 40.4 | 40.2 | 35.9 | 27.7 |
| SiO₂ | 30.9 | 31.7 | 34.6 | 34.8 | 30.5 | 32.5 | 31.4 | 31.3 | 33.3 | 21.9 |
| ZnO | 12.4 | 17.4 | 15.2 | 15.3 | 12.2 | 12.3 | 13.6 | 14.7 | 9.7 | 27.0 |
| Li₂O | 0 | 0 | 0.2 | 0 | 0 | 0 | 0 | 0 | 3.6 | 12.0 |
| Na₂O | 5.4 | 4.9 | 1.3 | 3.6 | 2.7 | 2.7 | 4.5 | 3.6 | 0 | 0 |
| K₂O | 10.3 | 10.1 | 13.6 | 10.9 | 14.2 | 12.2 | 10.2 | 10.2 | 11.2 | 6.2 |
| MgO | 0 | 0 | 0 | 0 | 0 | 0 | 0 | 0 | 6.4 | 0 |
| BaO | 0 | 0 | 0 | 0 | 0 | 0 | 0 | 0 | 0 | 15.2 |
| Al₂O₃ | 0 | 3.6 | 0 | 0 | 0 | 0 | 0 | 0 | 0 | 0 |
| CuO | 1.2 | 0 | 0 | 0 | 1.1 | 0 | 0 | 0 | 0 | 0 |
| Ts | 595 | 598 | 613 | 614 | 596 | 605 | 597 | 600 | 604 | 598 |
| ε | 6.5 | 6.9 | — | 6.4 | 6.4 | 6.2 | 6.4 | 6.3 | — | 7.8 |
| α | 83 | 83 | 81 | 82 | 85 | 86 | 82 | 77 | 82 | 79 |
| E | 74 | 63 | 60 | 61 | 58 | 58 | — | 59 | 76 | 75 |
| Kc | 0.84 | 0.78 | 0.79 | 0.76 | 0.75 | 0.74 | — | 0.84 | 0.71 | 0.60 |
| S | 1.7 | 1.7 | 2.0 | 1.7 | 1.6 | 1.5 | — | 2.6 | 1.2 | 1.0 |
| H/H₀ | 1.9 | 1.5 | — | — | — | — | 2.1 | 2.3 | 1.0 | 1.2 |
| W | −7.2 | 2.9 | −15.8 | −8.4 | −21.8 | −19.9 | −14.1 | −18.6 | 89.8 | 53.9 |

TABLE 2

| | Ex. | | | | | | | | | |
|---|---|---|---|---|---|---|---|---|---|---|
| | 1 | 2 | 3 | 4 | 5 | 6 | 7 | 8 | 9 | 10 |
| B₂O₃ | 39.5 | 32.5 | 35.0 | 35.0 | 39.5 | 40.0 | 40.0 | 40.0 | 32.5 | 30.0 |
| SiO₂ | 35.5 | 37.0 | 40.0 | 40.0 | 35.5 | 37.5 | 36.0 | 36.0 | 35.0 | 27.5 |
| ZnO | 10.5 | 15.0 | 13.0 | 13.0 | 10.5 | 10.5 | 11.5 | 12.5 | 7.5 | 25.0 |
| Li₂O | 0 | 0 | 0.5 | 0 | 0 | 0 | 0 | 0 | 7.5 | 5.0 |
| Na₂O | 6.0 | 5.5 | 1.5 | 4.0 | 3.0 | 3.0 | 5.0 | 4.0 | 0 | 0 |
| K₂O | 7.5 | 7.5 | 10.0 | 8.0 | 10.5 | 9.0 | 7.5 | 7.5 | 7.5 | 5.0 |
| MgO | 0 | 0 | 0 | 0 | 0 | 0 | 0 | 0 | 10.0 | 0 |
| BaO | 0 | 0 | 0 | 0 | 0 | 0 | 0 | 0 | 0 | 7.5 |
| Al₂O₃ | 0 | 2.5 | 0 | 0 | 0 | 0 | 0 | 0 | 0 | 0 |
| CuO | 1.0 | 0 | 0 | 0 | 1.0 | 0 | 0 | 0 | 0 | 0 |

Starting materials were formulated and mixed so that the composition would be as shown by mass % in lines from B₂O₃ to Al₂O₃ or to CuO in Tables 3 and 4. Each mixture was heated to 1,250° C. and melted for 60 minutes by means of a platinum crucible. Examples 11 to 27 represent Examples for the glass 2 or 3 of the present invention, and Examples 28 to 33 represent Comparative Examples. Further, Example 29 is the same as Example 10. Glass in each Examples 18, 20 and 26 was not melt, and its Ts, Kc, S and W were estimated by the calculation of its composition. Further, in Tables 5 and 6, each glass component is shown by mol %.

The obtained molten glass was partly poured into stainless-steel rollers to be processed into flakes. The glass flakes obtained were subjected to dry grinding for 16 hours by an alumina ball mill, followed by airflow classification, to prepare a glass powder having a D₅₀ of from 2 to 4 μm.

Using this glass powder as a sample, a Ts (unit: ° C.) was measured by means of a differential thermal analyzer (DTA).

Further, the rest of the above molten glass was poured into a stainless-steel frame and annealed. The annealed glass was partly processed into a cylindrical shape with a length of 20 mm and a diameter of 5 mm, and using a quartz glass as a standard sample, α of such a glass was measured by using a horizontal differential detection system thermal dilatometer, TD 5010SA-N, manufactured by Bruker AXS. The results are shown in Tables (unit: 10⁻⁷/° C.).

The rest of the annealed glass was processed into a plate-shape having a thickness of 10 mm, and an elastic modulus E (unit: GPa) was measured in accordance with JIS R 1602-1995 “Testing methods for elastic modulus of fine ceramics 5.3 Ultrasonic pulse method”.

Further, one side of the above glass which was processed into a plate-shape, was mirror-polished, and in order to remove the remaining stress, the glass was held at a temperature of from 500° C. to 520° C. for one hour and then annealed. By using such a specimen, Kc (unit: MPa·m^{1/2}) was measured by the above method. However, the pressing load of the Vickers indenter was selected depending on the tendency of cracking formation and the size of cracks, and the measurement was carried out by using a load of 1 kg in Examples 11, 12, 14 to 16, and 30, 2 kg in Example 17, 19, 21 to 23 and 28, and 200 g in Examples 29, 31, 32 and 33.

Further, 100 g of the above glass powder was kneaded with 25 g of an organic vehicle having 10 mass % of ethyl cellulose dissolved in α-terpineol or the like, to prepare a glass paste. The paste was uniformly screen-printed on the above conventional glass substrate having a size of 100 mm×100 mm and a thickness of 2.8 mm, and dried at 120° C. for 10 minutes. Then, such a glass substrate was heated at a temperature-raising rate of 10° C. per minute up to 570° C., and maintained at the temperature for 30 minutes to carry out firing, whereby a glass layer was formed on the glass substrate.

Along a portion of 100 mm in length on a diagonal of such a glass layer-coated glass substrate, its warpage W (unit: μm) was measured by using a surface roughness meter.

By using values of E, Kc and α, which were obtained in the above manner, and using a value of α₀ of the glass substrate, the above S was calculated.

Further, H was measured with respect to such a glass layer-coated glass substrate, and by using separately measured H₀, H/H₀ was calculated.

The results of measurements or calculation are shown in Tables. “−” in Tables mean that measurements were not carried out.

In Examples 28, 29, 31 and 32, warpage (the absolute value of W) is large, and in Example 30, Ts is high, whereby it is difficult to produce a PDP front substrate by using a conventional glass substrate.

TABLE 3

| | Ex. | | | | | | | | | | |
|---|---|---|---|---|---|---|---|---|---|---|---|
| | 11 | 12 | 13 | 14 | 15 | 16 | 17 | 18 | 19 | 20 | 21 |
| B₂O₃ | 38.3 | 39.8 | 39.0 | 39.4 | 39.8 | 39.4 | 42.3 | 41.3 | 45.2 | 45.1 | 47.1 |
| SiO₂ | 28.9 | 25.8 | 29.5 | 25.4 | 25.7 | 25.5 | 25.5 | 25.5 | 26.9 | 26.3 | 27.1 |
| ZnO | 22.3 | 23.3 | 22.8 | 23.1 | 23.8 | 23.1 | 20.3 | 19.6 | 12.3 | 11.7 | 14.7 |
| Li₂O | 0.4 | 0 | 2.1 | 0 | 0.4 | 0.6 | 0.3 | 0.3 | 0 | 0 | 0 |
| Na₂O | 3.6 | 4.4 | 0 | 2.6 | 2.2 | 0 | 0 | 0.8 | 5.4 | 5.4 | 2.8 |
| K₂O | 6.5 | 6.7 | 6.7 | 9.3 | 8.1 | 11.3 | 11.6 | 11.1 | 10.2 | 9.5 | 7.1 |
| Al₂O₃ | 0 | 0 | 0 | 0 | 0 | 0 | 0 | 1.4 | 0 | 1.5 | 0 |
| CaO | 0 | 0 | 0 | 0 | 0 | 0 | 0 | 0 | 0 | 0 | 0 |
| BaO | 0 | 0 | 0 | 0 | 0 | 0 | 0 | 0 | 0 | 0 | 0 |
| CuO | 0 | 0 | 0 | 0 | 0 | 0 | 0 | 0 | 0 | 0 | 1.2 |
| Ts | 599 | 605 | 605 | 600 | 598 | 600 | 599 | 611 | 585 | 591 | 595 |
| ε | — | 6.5 | — | 6.4 | 6.2 | 6.3 | 6.4 | — | 6.4 | 6.1 | 5.7 |
| α | 67 | 72 | 63 | 75 | 69 | 71 | 71 | 73 | 87 | 87 | 61 |
| E | 65 | 64 | 67 | 62 | 64 | 61 | 59 | 58 | 61 | 59 | 53 |
| Kc | 0.77 | 0.76 | — | 0.73 | 0.75 | 0.78 | 0.80 | 0.78 | 0.89 | 0.81 | 0.81 |
| S | 2.7 | 2.3 | — | 2.0 | 2.4 | 2.5 | 2.7 | 2.5 | 2.0 | 1.7 | 4.2 |
| H/H₀ | 2.5 | 2.2 | 3.3 | 2.0 | 2.5 | 2.5 | 2.5 | — | 1.7 | — | 4.2 |
| W | 28.0 | 7.8 | 43.7 | −22.0 | 23.6 | 14.2 | −12.9 | 25 | 6.3 | 12.5 | — |

TABLE 4

| | Ex. | | | | | | | | | | | |
|---|---|---|---|---|---|---|---|---|---|---|---|---|
| | 22 | 23 | 24 | 25 | 26 | 27 | 28 | 29 | 30 | 31 | 32 | 33 |
| B₂O₃ | 46.4 | 45.7 | 44.8 | 45.6 | 44.9 | 45.9 | 38.9 | 27.7 | 30.0 | 35.5 | 33.0 | 29.3 |
| SiO₂ | 26.7 | 26.3 | 25.8 | 26.3 | 31.7 | 26.4 | 25.4 | 21.9 | 20.0 | 11.5 | 14.5 | 7.2 |
| ZnO | 14.5 | 14.2 | 17.5 | 17.8 | 11.9 | 14.3 | 22.8 | 27.0 | 27.0 | 40.0 | 42.0 | 39.2 |
| Li₂O | 0 | 0 | 0 | 0 | 0 | 0 | 0 | 2.0 | 0 | 0 | 0 | 0 |
| Na₂O | 2.7 | 3.6 | 3.6 | 3.6 | 4.5 | 2.7 | 0 | 0 | 0 | 1.0 | 0 | 1.9 |
| K₂O | 8.4 | 9.6 | 6.8 | 5.5 | 6.9 | 8.3 | 13.2 | 6.2 | 8.0 | 9.0 | 10.0 | 2.8 |
| Al₂O₃ | 0 | 0 | 0 | 0 | 0 | 0 | 0 | 0 | 5.0 | 1.0 | 0 | 0 |
| CaO | 0 | 0 | 0 | 0 | 0 | 0 | 0 | 0 | 0 | 2.0 | 0 | 0 |
| BaO | 0 | 0 | 0 | 0 | 0 | 0 | 0 | 15.2 | 10.0 | 0 | 0 | 18.5 |
| CuO | 1.2 | 0.6 | 1.2 | 1.1 | 0 | 2.3 | 0 | 0 | 0 | 0 | 0.5 | 1.1 |
| Ts | 583 | 582 | 601 | 603 | 609 | 589 | 610 | 598 | 639 | 596 | 614 | 599 |
| ε | 5.9 | 6.4 | 6.0 | 5.9 | 6.1 | — | — | 7.8 | — | 7.9 | 7.1 | 8.7 |
| A | 72 | 78 | 68 | 66 | 76 | — | 73 | 79 | 71 | 73 | 63 | 75 |
| E | 54 | 53 | — | — | 57 | — | 69 | 75 | 63 | 67 | 66 | 74 |
| Kc | 0.82 | 0.75 | — | — | 0.84 | — | 0.83 | 0.60 | 0.77 | 0.65 | 0.65 | 0.54 |
| S | 3.0 | 2.3 | — | — | 2.7 | — | 2.4 | 1.0 | 2.5 | 1.6 | 2.3 | 1.0 |
| H/H₀ | 3.2 | 2.5 | 3.3 | 4.3 | — | 3.0 | 2.4 | 1.2 | — | 1.3 | — | — |
| W | — | — | — | — | — | — | −71.2 | 53.9 | — | −59.6 | −70 | — |

TABLE 5

| | Ex. | | | | | | | | | | |
|---|---|---|---|---|---|---|---|---|---|---|---|
| | 11 | 12 | 13 | 14 | 15 | 16 | 17 | 18 | 19 | 20 | 21 |
| B₂O₃ | 38.1 | 40.0 | 38.1 | 40.0 | 40.0 | 40.0 | 42.9 | 42.0 | 45.0 | 45.0 | 46.8 |
| SiO₂ | 33.3 | 30.0 | 33.3 | 30.0 | 30.0 | 30.0 | 30.0 | 30.0 | 31.0 | 31.0 | 31.2 |
| ZnO | 19.0 | 20.0 | 19.0 | 20.0 | 20.5 | 20.0 | 17.6 | 17.0 | 10.5 | 10.0 | 12.5 |
| Li₂O | 0.8 | 0 | 4.8 | 0 | 1.0 | 1.5 | 0.8 | 0.8 | 0 | 0 | 0 |
| Na₂O | 4.0 | 5.0 | 0 | 3.0 | 2.5 | 0 | 0 | 0.9 | 6.0 | 6.0 | 3.1 |
| K₂O | 4.8 | 5.0 | 4.8 | 7.0 | 6.0 | 8.5 | 8.7 | 8.3 | 7.5 | 7.0 | 5.2 |
| Al₂O₃ | 0 | 0 | 0 | 0 | 0 | 0 | 0 | 1.0 | 0 | 1.0 | 0 |
| CaO | 0 | 0 | 0 | 0 | 0 | 0 | 0 | 0 | 0 | 0 | 0 |
| BaO | 0 | 0 | 0 | 0 | 0 | 0 | 0 | 0 | 0 | 0 | 0 |
| CuO | 0 | 0 | 0 | 0 | 0 | 0 | 0 | 0 | 0 | 0 | 1.1 |

TABLE 6

| | Ex. | | | | | | | | | | | |
|---|---|---|---|---|---|---|---|---|---|---|---|---|
| | 22 | 23 | 24 | 25 | 26 | 27 | 28 | 29 | 30 | 31 | 32 | 33 |
| B₂O₃ | 46.3 | 45.7 | 45.0 | 45.5 | 44.0 | 45.9 | 40.0 | 30.0 | 33.3 | 37.8 | 35.3 | 34.7 |
| SiO₂ | 30.9 | 30.5 | 30.0 | 30.3 | 36.0 | 30.6 | 30.0 | 27.5 | 25.7 | 14.2 | 18.0 | 9.9 |
| ZnO | 12.4 | 12.2 | 15.0 | 15.2 | 10.0 | 12.2 | 20.0 | 25.0 | 25.6 | 36.4 | 38.4 | 39.7 |
| Li₂O | 0 | 0 | 0 | 0 | 0 | 0 | 0 | 5.0 | 0 | 0 | 0 | 0 |
| Na₂O | 3.0 | 4.1 | 4.0 | 4.0 | 5.0 | 3.1 | 0 | 0 | 0 | 1.2 | 0 | 2.5 |
| K₂O | 6.2 | 7.1 | 5.0 | 4.0 | 5.0 | 6.2 | 10.0 | 5.0 | 6.6 | 7.1 | 7.9 | 2.5 |
| Al₂O₃ | 0 | 0 | 0 | 0 | 0 | 0 | 0 | 0 | 3.8 | 0.7 | 0 | 2.4 |
| CaO | 0 | 0 | 0 | 0 | 0 | 0 | 0 | 0 | 0 | 2.6 | 0 | 0 |
| BaO | 0 | 0 | 0 | 0 | 0 | 0 | 0 | 7.5 | 5.0 | 0 | 0 | 9.9 |
| CuO | 1.1 | 0.5 | 1.0 | 1.0 | 0 | 2.0 | 0 | 0 | 0 | 0 | 0.5 | 0.8 |

Further, starting materials were formulated and mixed so that the composition would be as shown by mass % in lines from B₂O₃ to CoO in Table 7. Each mixture was heated to 1,250° C. and melted for 60 minutes by means of a platinum crucible to obtain a glass in each of Examples 34 to 40 (in Table 8, glass components are shown by mol %).

Examples 34 and 35 are Examples of the present invention, and Examples 36 to 40 are Comparative Examples.

Ts of each glass was measured, and ε and W were also measured with respect to Examples 34, 35, 36 and 40. Further, α, E and Kc were estimated from each composition, and S was calculated by using such estimated values.

TABLE 7

| | 34 | 35 | 36 | 37 | 38 | 39 | 40 |
|---|---|---|---|---|---|---|---|
| B₂O₃ | 46.5 | 40.2 | 42.3 | 40.4 | 42.6 | 41.1 | 42.9 |
| SiO₂ | 26.7 | 32.5 | 32.9 | 26.2 | 33.1 | 31.9 | 33.3 |
| ZnO | 10.9 | 12.3 | 13.0 | 12.7 | 13.0 | 13.2 | 13.2 |
| Li₂O | 1.1 | 0 | 4.1 | 2.4 | 4.1 | 2.0 | 4.1 |
| Na₂O | 0 | 2.7 | 0 | 0 | 0 | 0 | 0 |
| K₂O | 11.9 | 12.2 | 6.5 | 6.2 | 6.5 | 11.8 | 6.5 |
| MgO | 3.0 | 0 | 0 | 0 | 0 | 0 | 0 |
| CuO | 0 | 0 | 1.2 | 1.2 | 0.6 | 0 | 0 |
| CoO | 0 | 0 | 0 | 0 | 0.1 | 0 | 0 |
| Ts | 618 | 605 | 587 | 589 | 594 | 588 | 592 |
| ε | 6.8 | 6.4 | — | — | — | 6.4 | 6.3 |
| α | 75 | 86 | 69 | 65 | 69 | 77 | 69 |
| E | 59 | 59 | 74 | 68 | 74 | 66 | 75 |
| Kc | 0.80 | 0.79 | 0.74 | 0.74 | 0.74 | 0.76 | 0.75 |
| S | 2.4 | 2.0 | 2.1 | 2.6 | 2.1 | 2.0 | 2.0 |
| H/H₀ | — | — | — | — | — | — | — |
| W | 18.2 | −19.9 | — | — | — | 78.7 | 87.8 |

TABLE 8

| | 34 | 35 | 36 | 37 | 38 | 39 | 40 |
|---|---|---|---|---|---|---|---|
| B₂O₃ | 45.0 | 40.0 | 39.6 | 39.6 | 39.8 | 40.0 | 40.0 |
| SiO₂ | 30.0 | 37.5 | 35.6 | 29.7 | 35.8 | 36.0 | 36.0 |
| ZnO | 9.0 | 10.5 | 10.4 | 19.8 | 10.4 | 11.0 | 10.5 |
| Li₂O | 2.5 | 0 | 8.9 | 5.4 | 8.9 | 4.5 | 9.0 |
| Na₂O | 0 | 3.0 | 0 | 0 | 0 | 0 | 0 |
| K₂O | 8.5 | 9.0 | 4.5 | 4.5 | 4.5 | 8.5 | 4.5 |
| MgO | 5.0 | 0 | 0 | 0 | 0 | 0 | 0 |
| CuO | 0 | 0 | 1.0 | 1.0 | 0.5 | 0 | 0 |
| CoO | 0 | 0 | 0 | 0 | 0.1 | 0 | 0 |

A powder of the glass in the above Example 1, 23 or 31, a SiO₂ powder (amorphous silica, SO-C2, manufactured by Admatechs) and TiO₂ powder (TIPAQUE A-220, manufactured by ISHIHARA SANGYO KAISYA, LTD) were mixed so that the composition would be as shown by mass % in lines in Table 9, whereby a glass ceramic composition was prepared. Examples A and B represent glass ceramic compositions of the present invention, and Example C represents Comparative Example. Further, in parenthesis, the content of each powder is shown by volume %.

100 g of each glass ceramic composition was kneaded with 25 g of an organic vehicle having 10 mass % of ethyl cellulose dissolved in α-terpineol or the like, to prepare a glass paste. The paste was uniformly screen-printed on the conventional glass substrate having a size of 100 mm×100 mm and a thickness of 2.8 mm, to have a film thickness of 20 μm after firing, and dried at 120° C. for 10 minutes. Then, such a glass substrate was heated at a temperature-raising rate of 10° C. per minute up to 570° C., and maintained at the temperature for 30 minutes to carry out firing.

With respect to the glass ceramic layer-coated glass substrate obtained in such a manner, a total luminous reflectance (unit: %) at 560 nm was measured by using a spectrophotometer, in accordance with JIS K 7375. The results are shown in Table 7. Further, when the substrate is used for a PD rear substrate, the total luminous reflectance is preferably at least 45%.

Further, H was measured, and by using separately measured H₀, H/H₀ was calculated. The results are shown in Table 9.

Further, measurements of dielectric constant were carried out by the following method. That is, on the glass substrate, a gold paste was applied, followed by drying to form a lower electrode, and then, the above glass ceramic paste was uniformly applied to have a film thickness of 20 μm after firing, followed by drying at 120° C. for 10 minutes. Such a glass substrate was heated at a temperature-raising rate of 10° C. per minute up to 570° C., and maintained at the temperature for 30 minutes to carry out firing. On the obtained film subjected to firing, the gold paste was screen-printed, followed by drying to form an upper electrode, and a dielectric constant of the above film subjected to firing was measured by using LCR meter. The results are shown in Table 9. Further, when the glass ceramic composition of the present invention is used as an electrode-covering layer of the PDP rear substrate, its dielectric constant is preferably at most 8.5.

TABLE 9

| | Ex | | |
|---|---|---|---|
| | A | B | C |
| Type of glass | 1 | 23 | 31 |
| Powder of glass | 89.3 (90) | 93.7 (95) | 95.5 (95) |
| SiO₂ powder | 6.1 (7) | 1.7 (2) | 1.2 (2) |
| TiO₂ powder | 4.6 (3) | 4.6 (3) | 3.2 (3) |
| Dielectric | 6.6 | 7.1 | 8.9 |
| constant | | | |
| H/H₀ | 2 | 2.2 | 1.1 |
| Reflectance | 50 | 52 | 50 |

The present invention is useful for PDP, a PDP front substrate, an electrode-covering glass of a PDP front substrate, a PDP rear substrate and an electrode-covering glass of a PDP rear substrate.

The entire disclosures of Japanese Patent Application No. 2007-170789 filed on Jun. 28, 2007, Japanese Patent Application No. 2007-182041 filed on Jul. 11, 2007 and Japanese Patent Application No. 2008-113782 filed on Apr. 24, 2008 including specifications, claims, drawings and summaries are incorporated herein by reference in their entireties.

What is claimed is:

1. A process for producing an electrode-formed glass substrate comprising forming electrodes on a glass substrate and covering the electrodes with glass, wherein the electrodes are covered with a lead-free glass comprising, as represented by mass % based on the following oxides, from 30 to 50% of B₂O₃, more than 25% and at most 35% of SiO₂, from 10 to 25% of ZnO, from 7 to 19% in total of K₂O and either one or both of Li₂O and Na₂O, and from 0 to 5% of Al₂O₃, and when the lead-free glass contains at least one component selected from the group consisting of MgO, CaO, SrO and BaO, the total of their contents is at most 5%, and when the molar fractions of Li₂O, Na₂O and K₂O are represented by l, n and k, respectively, l is at most 0.025, and l+n+k is from 0.07 to 0.17.

2. The process for producing an electrode-formed glass substrate according to claim 1, wherein the above lead-free glass has a SiO₂ content of more than 30%, a ZnO content of at most 20% and a total content of Li₂O, Na₂O and K₂O of at least 9%, and l+n+k is at least 0.09.

3. The process for producing an electrode-formed glass substrate according to claim 1, wherein the above lead-free glass has a B₂O₃ content of at least 35%, a SiO₂ content of at most 30%, a total content of B₂O₃ and SiO₂ of at least 60% and a total content of Li₂O, Na₂O and K₂O of at most 17%, and l+n+k is at most 0.15.

4. The process for producing an electrode-formed glass substrate according to claim 3, wherein the above lead-free glass has a ZnO content of less than 15%.

5. The process for producing an electrode-formed glass substrate according to claim 4, wherein the above lead-free glass has a B₂O₃ content of at least 40%, and a total content of Li₂O, Na₂O and K₂O of at least 10%.

6. The process for producing an electrode-formed glass substrate according to claim 3, wherein the above lead-free glass has a B₂O₃ content of at most 45%, a ZnO content of at least 15%, and a total content of Li₂O, Na₂O and K₂O of at most 14%.

7. The process for producing an electrode-formed glass substrate according to claim 1, wherein the above lead-free glass has a B₂O₃ content of at least 43%, a SiO₂ content of at most 33%, a total content of B₂O₃ and SiO₂ of at least 70%, a ZnO content of at most 23%, a Li2O content of from 0 to 0.5%, a Na₂O content of from 2 to 5%, a K₂O content of from 4 to 9%, and a total content of Li₂O, Na₂O and K₂O of at most 12%.

8. The process for producing an electrode-formed glass substrate according to claim 1, wherein in the above lead-free glass, l/(l+n+k) is at most 0.2.

9. The process for producing an electrode-formed glass substrate according to claim 1, wherein the above lead-free glass has a softening point of at most 630° C.

10. The process for producing an electrode-formed glass substrate according to claim 1, wherein the above lead-free glass has a dielectric constant of at most 8.5 at 1 MHz.

11. A glass ceramic composition for covering electrodes comprising a powder of a lead-free glass and a powder of titanium oxide, wherein the lead-free glass comprises, as represented by mass % based on the following oxides, from 30 to 50% of B₂O₃, more than 25% and at most 33% of SiO₂, from 10 to 25% of ZnO, from 9 to 19% in total of K₂O and either one or both of Li₂O and Na₂O, and from 0 to 5% of Al₂O₃, and when the lead-free glass contains at least one component selected from the group consisting of MgO, CaO, SrO and BaO, the total of their contents is at most 5%, and when the molar fractions of Li₂O, Na₂O and K₂O are represented by l, n and k, respectively, l is at most 0.025, and l+n+k is from 0.08 to 0.17.

12. The glass ceramic composition for covering electrodes according to claim 11, which comprises, as represented by mass %, from 90 to 99.9% of the powder of the above lead-free glass and from 0.1 to 10% of the powder of titanium oxide.

13. A process for producing an electrode-formed glass substrate comprising forming electrodes on a glass substrate and covering the electrodes with glass, wherein the glass ceramic composition for covering electrodes as defined in claim 11, is fired to form glass to cover the electrodes.

14. A process for producing an electrode-formed glass substrate comprising forming electrodes on a glass substrate and covering the electrodes with glass, wherein the glass ceramic composition for covering electrodes as defined in claim 12, is fired to form glass to cover the electrodes.
